(19) United States
(12) Patent Application Publication
(10) Pub. No.: US 2009/0044224 A1
(43) Pub. Date: Feb. 12, 2009

(54) DYNAMIC CHANNEL SWITCHING

(75) Inventor: James A. Hymel, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/834,962

(22) Filed: Aug. 7, 2007

(51) Int. Cl. H04N 5/445

(52) U.S. Cl. 725/46

(57) ABSTRACT

Apparatus and method for channel switching in a handheld digital television terminal with reduced power consumption. Embodiments of the invention reduce channel switching latency caused by time-slicing and decoding delays. A method includes providing media content derived from a selected programming channel to a handheld digital television user. A variety of occurrences indicative of an increased likelihood that the user may select another channel are detected. The occurrences include program content boundaries, changes in program content, and user initiated channel switches. After an occurrence indicative of an increased likelihood that the user may select another channel is detected, multiple program channels are decoded for a time interval to facilitate program switching.

### BACKGROUND

Digital television is a broadcasting technology that transmits video and audio information as a digital bitstream. In contrast to analog broadcast technology, digital television broadcasting enables transmission of higher resolution audio and video content, and more efficient use of available electromagnetic spectrum. Digital television broadcasting will become the dominant world-wide television broadcasting technology as analog systems are phased out over time. Numerous jurisdictions have completed the transition to digital broadcasting and the U.S. is scheduled to follow suit.

Digital video broadcasting adapted to handheld receivers, such as cellular telephones, Personal Digital Assistants, etc., is becoming an increasingly important area of digital television broadcasting. With the advent of mobile television broadcasting, viewers are no longer bound to the television receivers in their homes or vehicles, but are enabled to view their choice of broadcast video wherever they are located.

There are a number of standards for multimedia broadcasting to handheld devices. The standards include Digital Multimedia Broadcasting (“DMB”), deployed primarily in South Korea; Integrated Services Digital Broadcasting (“ISDB-T”), used in Japan; MediaFLO, a proprietary Qualcomm system; and Digital Video Broadcasting-Handheld (“DVB-H), an adaptation of Digital Video Broadcasting-Terrestrial (“DVB-T”), the European consortium standard for terrestrial digital broadcasting.

Irrespective of the broadcast standard, in order to meet users' expectations, handheld television systems should provide high-quality video and audio, robust reception, and engaging content. Moreover, because mobile receivers are dependent on batteries for power, battery life is an important consideration in whether handheld video systems gain user acceptance. Therefore, while striving to enhance the viewing experience, the power consumption of mobile television receivers should be managed to optimize battery life.

### SUMMARY

Accordingly, there are herein disclosed techniques for facilitating channel switching in a handheld television terminal while decreasing power consumption. In accordance with at least some embodiments a method includes providing media content derived from a selected programming channel to a handheld digital television user. When an occurrence indicative of an increased likelihood that the user may select another channel is detected, multiple program channels are decoded for a subsequent time interval to facilitate channel switching.

In other embodiments, an apparatus includes circuitry for outputting media content derived from a selected programming channel to a user. The apparatus further includes a decoder that decodes a plurality of program channels, and a controller coupled to the decoder. The controller detects an occurrence indicative of an increased likelihood that a user may select another channel and, to facilitate channel switching, directs the decoder to decode a plurality of channels for a time interval after the occurrence is detected.

In yet other embodiments, apparatus includes means for outputting media content to a digital television user. The apparatus also includes means for detecting an occurrence indicative of an increased likelihood that the user will switch channels. Further, the apparatus includes a means for decoding a plurality of program channels for a time interval after detection of the occurrence.

### Notation and Nomenclature

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” and “e.g.” are used in an open-ended fashion, and thus should be interpreted to mean “including, but not limited to . . . ”. The term “couple” or “couples” is intended to mean either an indirect or direct connection. Thus, if a first component couples to a second component, that connection may be through a direct connection, or through an indirect connection via other components and connections. The term “system” refers to a collection of two or more hardware and/or software components, and may be used to refer to an electronic device or devices, or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### BRIEF DESCRIPTION OF THE DRAWINGS

In the following detailed description, reference will be made to the accompanying drawings, in which:

FIG. 1 shows an illustrative handheld television system in accordance with various preferred embodiments of the invention.

FIG. 2 shows a block diagram of an illustrative handheld television receiver in accordance with at least some preferred embodiments of the invention.

FIG. 3 shows a flow diagram for a method of reducing channel switching time in a handheld television receiver while reducing power consumption in accordance with preferred embodiments of the invention.

The drawings show illustrative embodiments that will be described in detail. However, the description and accompanying drawings are not intended to limit the claimed invention to the illustrative embodiments, but to the contrary, the intention is to disclose and protect all modifications, equivalents, and alternatives falling within the spirit and scope of the appended claims.

### DETAILED DESCRIPTION

Disclosed herein are various systems and methods for reducing power consumption in a handheld digital television receiver while enabling fast channel switching. The disclosed embodiments include method and apparatus for anticipating user channel switches, and in response, decoding multiple channels which the user may select. The embodiments reduce receiver power consumption resulting in increased battery life and increased receiver operating time. While embodiments of the invention are described primarily in the context of a handheld wireless television receiver, embodiments may also be applicable reducing power consumption in a wide variety of fixed and portable digital television, audio, and multi-media receivers.

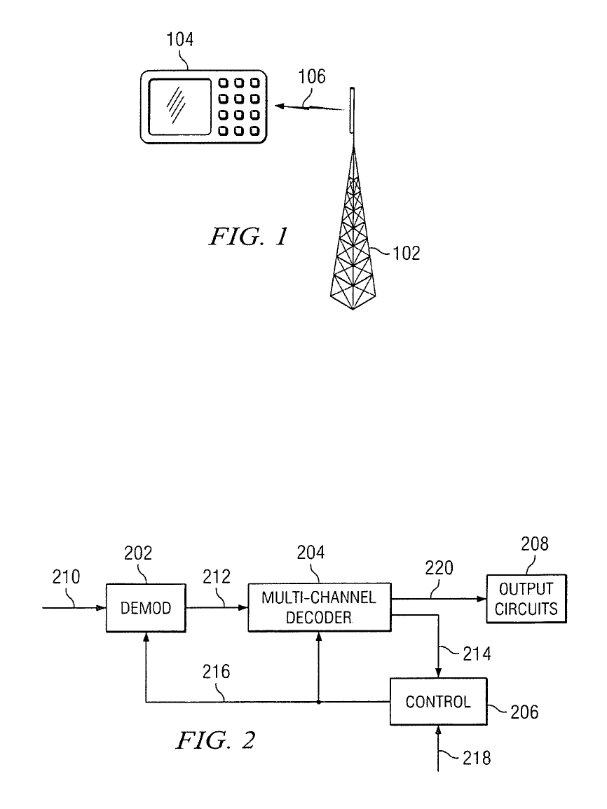

FIG. 1 shows an illustrative handheld digital television system 100 in accordance with various preferred embodiments of the invention. The illustrative handheld digital television system includes a transmission tower 102 and a handheld receiver 104. The transmission tower 102 may be terrestrial, or alternatively may be satellite-based. The handheld receiver 104 may be included in a cellular telephone, personal digital assistant, or a variety of other devices adapted to receive digital television signals. Although the system may, to some extent, be integrated with the cellular telephone system as a means of providing user interactivity, the system is, in significant part, a broadcast system whereby media content is transmitted over the air by tower 102 and received by any number of handheld receivers 104 within range of transmission tower 102. Media content includes video, audio, text, graphics, and other forms of information either separately or combined. Note that in practice a handheld digital television system may include one or more transmission towers each with a corresponding coverage area, and one or more handheld receivers may be present within the coverage area of a transmission tower.

Broadcast transmission signal 106 may carry a plurality of digital program channels from which the user may select. The time delay between when the user initiates a channel change and when the media content of the new channel are output to the user is one factor affecting user satisfaction. Digital video display is dependent on receiving sufficient information to produce a picture. This often means waiting to receive an I-frame, an independent data set representing a video frame without reference to any prior video frame. I-frames are usually transmitted at a regular interval, and that interval may dictate, at least in part, the maximum channel switching time.

In order to improve battery life in handheld television receivers, some embodiments of a handheld video system may employ “time-slicing,” a transmission scheme that tends to further increase channel switching time. The full bandwidth of the transmit stream may be, for example, 10 megabits per second. However, the media content of a television channel may have a fairly low bit rate, for example 500 kilobits per second. When employing time-slicing, a channel is transmitted as a burst during an allocated time slot, allowing the handheld receiver 104 to reduce power consumption by demodulating and decoding signals only during the relatively small time interval when a channel of interest is being transmitted. Additional channels may be transmitted in other time slots. Sections of the receiver 104 may be powered off or disabled to reduce power consumption during time intervals when a selected channel is not being transmitted. For example, using the 500 Kbps and 10 Mbps parameters mentioned above, when decoding a single channel the receiver 104 may be powered off approximately 95% of the time, resulting in significant power savings. In practice, the receiver may be powered on for a somewhat higher percentage of the time to allow for receiver synchronization. Unfortunately, while an effective power saving methodology, time-slicing tends to negatively affect channel switching as the receiver must wait for the next burst to receive data from a newly selected channel. For example, a 2 megabit burst using a 10 Mbps transmit stream and a 500 Kbps data rate as above, is 200 ms in duration and requires that a burst be transmitted only once every four seconds. Thus, waiting for the next burst after a channel switch may result in significant latency in outputting the selected channel.

One possible solution to reducing channel switching latency is to continuously decode and buffer multiple channels. Unfortunately, while providing for quick channel changes, this solution results in increased power consumption, and a corresponding decrease in battery life. The embodiments of the present disclosure provide power saving techniques for handheld digital television receivers. The preferred embodiments provide rapid channel switching while viewing mobile television on time sliced systems and provide reduced power consumption when compared to continuous decoding. Therefore, handheld digital television receiver 104 preferably employs the apparatus and method of the disclosed embodiments to accelerate channel switching while reducing power consumption.

The preferred embodiments of the invention provide fast channel switching at reduced power by decoding multiple channels during time intervals when the handset user is most likely to request a channel change. At other times only the user selected channel is decoded to reduce power consumption. Most channel changes occur near the start of a television program, during commercials, near the end of a television program, or in close temporal proximity to a prior channel change. The preferred embodiments of the invention detect the conditions that indicate high likelihood of a channel change and decode multiple channels for a time interval surrounding those events or conditions. For example, during periods of increased channel switching likelihood, channels adjacent to the currently selected channel may be decoded in addition to the currently selected channel. Alternatively, the handset may adapt to the users channel browsing habits and decode the channels most likely to be selected after the current channel based on browsing history. The user may also program the handset to decode multiple channels in accordance with a preferred browsing pattern.

The time period surrounding the start or end of a program is one interval when the likelihood of a channel change increases. Embodiments of the invention determine the start or end of a television program by several methods. Some embodiments may assume that programs begin and end on half hour boundaries. These embodiments may begin decoding multiple channels, for example, several minutes prior to a half hour time boundary and continue decoding multiple channels until several minutes after the half hour boundary. Other embodiments of the invention may use information extracted from an electronic service guide (“ESG”) to determine when programs begin or end. The ESG is a guide to scheduled broadcast programming transmitted within the broadcast transmit stream. Decoding of multiple channels may, for example, begin several minutes before and end several minutes after the program start and end times indicated by the ESG.

Because channel changes often occur during commercials, embodiments of the invention detect changes in program content, including those indicating the presence of a commercial advertisement or other break in programming, and initiate multi-channel decoding. A variety of methods for identifying commercials are available and applicable to the embodiments of the invention. For example, detection of monochrome black frames with a silent audio track, detection of commercial block introduction sequences, lack of an on-screen network logo, and an increase in audio volume are common indicators of a commercial advertising segment. Upon detecting a commercial segment, embodiments of the invention initiate decoding of a plurality of channels and continue to decode multiple channels until the commercial segment ends, or alternatively for a time interval after detection of each advertisement indicator.

Embodiments of the invention also decode multiple channels for a time interval after the user selects a new channel. The wide variety of programming available for handheld television stimulates the modern propensity to “channel surf,” that is to scan the channels for programs of interest. By decoding multiple channels, newly selected programming is expeditiously output, enhancing the viewing experience.

FIG. 2 shows a block diagram of an illustrative handheld receiver 104 in accordance with at least some preferred embodiments of the invention. Demodulator block 202 extracts the transport stream 212 from the down converted received radio frequency signal 210. In the case of an Orthogonal Frequency Division Multiplexing (“OFDM”) demodulator, for example, demodulator 202 may include cyclic prefix removal and Fast Fourier Transform (“FFT”) systems. Decoder 204 is coupled to demodulator 202. Decoder 204 decodes the various media content channels carried by the transport stream. In accordance with the preferred embodiments, decoder 204 processes multiple channels only during time intervals when the user is most likely to select a new channel, and processes a single user selected channel at other times. A control block 206 is coupled to the demodulator 202 and the decoder 204. The control block 206 detects occurrences indicating an increased likelihood that the user will select another channel and instructs the demodulator 202 and the decoder 204 to process multiple channels. The control block 206 monitors user input 218 to detect user initiated channel changes. Decoder output 214 may indicate a content change, such as a commercial segment, and the control block 206 may track time internally and/or employ ESG data to determine program start and end times. Control block output 216 may direct the demodulator 202 and the decoder 204 to process one or more specified channels. Video and audio signals 220 produced by decoder 204 are output to the user through output circuits 208. The demodulator 202, decoder 204, and control blocks 206 may be implemented in a digital signal processor, or other processor, and associated software, or in fixed or programmable logic appropriately configured, or equivalent circuitry.

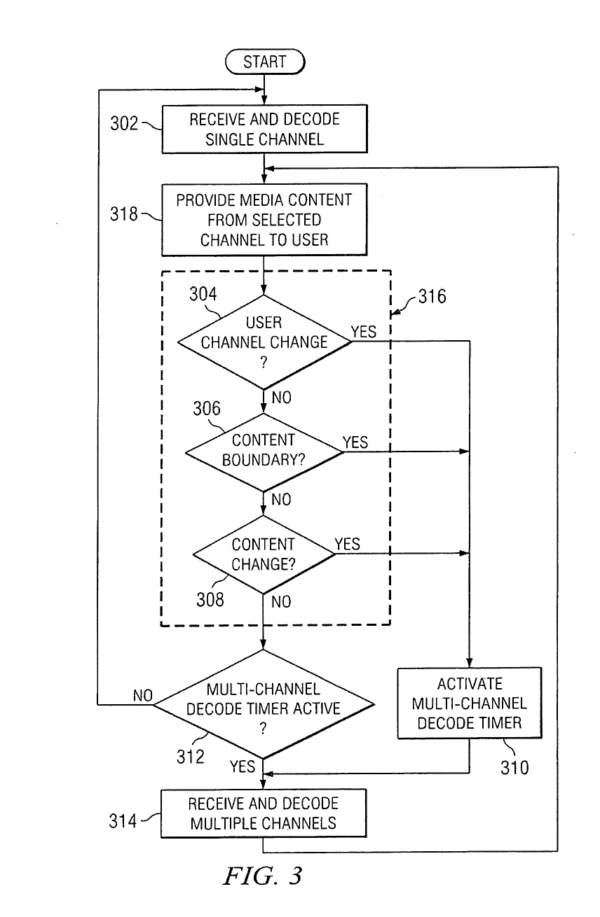

FIG. 3 shows a flow diagram for a method of reducing channel switching time in a handheld television receiver while reducing power consumption in accordance with preferred embodiments of the invention. Though depicted sequentially as a matter of convenience, at least some of the actions shown can be performed in a different order and/or performed in parallel. In block 302, to optimize battery life, the handheld digital television receiver receives and decodes a single selected channel. Media content derived from a selected channel is provided to the user in block 318.

To improve channel switching time, the receiver detects conditions indicative of an increased likelihood of channel change in block 316. In block 304, if the user selects a new channel, a multi-channel decode timer is activated in block 310, and the receiver receives and decodes multiple channels likely to be selected by the viewer in block 314. If no user directed channel change is detected in block 304, the receiver checks for a content boundary, such as the start or end of the current program on the selected channel in block 306. If a content boundary is detected, meaning in practice a specified time interval prior to the actual content boundary, a multi-channel decode timer is activated in block 310, and the receiver receives and decodes multiple channels likely to be selected by the viewer in block 314. If no content boundary is detected in block 306, the receiver checks for a change in programming content, for example, the onset of a commercial segment, in block 308. If a commercial segment is detected in block 308, by detection of black silent frames or other means, a multi-channel decode timer is activated in block 310, and the receiver receives and decodes multiple channels likely to be selected by the viewer in block 314. Note that the various indicators of increased channel switching likelihood may employ different timers and/or different multi-channel decode durations and/or different multi-channel decode groupings.

In block 312, the receiver determines whether multiple channels are being decoded. If all multi-channel decode timers are inactive, the receiver performs single channel decoding, for reduced power consumption, in block 302. If a multi-channel decode timer is active in block 312, multi-channel decoding continues in block 314.

While illustrative embodiments of this invention have been shown and described, modifications thereof can be made by one skilled in the art without departing from the spirit or teaching of this invention. The embodiments described herein are illustrative and are not limiting. Many variations and modifications of the system and apparatus are possible and are within the scope of the invention. Accordingly, the scope of protection is not limited to the embodiments described herein, but is only limited by the claims which follow, the scope of which shall include all equivalents of the subject matter of the claims.

What is claimed is:

1. A method comprising:
providing media content derived from a selected programming channel to a digital television user;
detecting an occurrence indicative of an increased likelihood that the user may select another channel;
decoding multiple program channels for a multi-channel decoding time interval after detection of the occurrence.

2. The method of claim 1, further comprising:
detecting a program content boundary in the selected channel; and
determining whether the program content boundary indicates an increased likelihood that the user may select another channel.

3. The method of claim 2, further comprising detecting an upcoming program content boundary prior to the programming content boundary and decoding multiple channels for a time period prior to the program content boundary.

4. The method of claim 2, further comprising determining a program content boundary from programming information provided by an electronic service guide.

5. The method of claim 1, further comprising:
detecting a change in the program content of the selected channel; and
determining whether the change in program content indicates an increased likelihood that the user may select another channel.

6. The method of claim 5, further comprising detecting the presence of a commercial advertisement.

7. The method of claim 1, further comprising:
detecting a user directed selection of a new selected channel; and
determining whether the selection of the new channel indicates an increased likelihood that the user may select another channel.

8. The method of claim 1, further comprising decoding only the selected channel after expiration of the multi-channel decoding time interval.

9. A system comprising:
circuitry for outputting media content derived from a selected programming channel to a user;
a decoder that decodes a plurality of program channels; and
a controller coupled to the decoder, the controller detects an occurrence indicative of an increased likelihood that a user may select another channel, and the controller directs the decoder to decode a plurality of channels for a multi-channel decoding time interval after the occurrence is detected.

10. The system of claim 9, wherein the controller detects a content boundary in the programming of the selected channel and determines whether the content boundary indicates an increased likelihood that the user may select another channel.

11. The system of claim 10, wherein the controller determines a program content boundary from programming information provided by an electronic service guide.

12. The system of claim 10, wherein the controller detects an upcoming program content boundary prior to the program content boundary and directs the decoder to decode a plurality of channels for a time period prior to the program content boundary.

13. The system of claim 9, wherein the controller detects a change in program content in the programming of the selected channel and determines whether the change in program content indicates an increased likelihood that the user may select another channel.

14. The system of claim 13, wherein a change in program content comprises a commercial advertisement.

15. The system of claim 9, wherein the controller detects a user directed selection of a new selected channel and determines whether the selection of the new channel indicates an increased likelihood that the user may select another channel.

16. The system of claim 9, wherein the controller directs the decoder to decode only the selected channel after expiration of the multi-channel decoding time interval.

17. A system comprising:
means for outputting media content to a digital television user;
means for detecting an occurrence indicative of an increased likelihood that the user will switch channels; and
means for decoding a plurality of program channels for a multi-channel decoding time interval after detection of the occurrence.

18. The system of claim 17, further comprising means for detecting a content boundary in the programming of the selected channel and determining whether the content boundary indicates an increased likelihood that the user may select another channel.

19. The system of claim 17, further comprising means for detecting a change in content in the programming of the selected channel and determining whether the change in content indicates an increased likelihood that the user may select another channel.

20. The system of claim 17, further comprising means for detecting a user directed selection of a new selected channel and determining whether the selection of the new channel indicates an increased likelihood that the user may select another channel.
